(19) United States
(12) Patent Application Publication
(10) Pub. No.: US 2003/0236878 A1
(43) Pub. Date: Dec. 25, 2003

(54) Statistical method for estimating the performances of computer systems

(76) Inventor: Masashi Egi, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/229,117

(22) Filed: Aug. 28, 2002

(30) Foreign Application Priority Data
Jun. 19, 2002 (JP) 2002-177885

(51) Int. Cl. G06F 15/173

(52) U.S. Cl. 709/224; 703/22

(57) ABSTRACT

A statistical method is developed for efficiently evaluating the response performance of one or more applications, which run in a computer system, under various utilization conditions and within a limited number of experiments. When making multiple load tests corresponding to various application utilization conditions, the method uses a performance monitor tool or a network monitor tool appended to an operating system with a load being applied to the system to first determine the numerical amount of the utilization of applications, numerical amount of the response performance of applications, numerical amount of the utilization of hardware resources, and numerical amount of the response times of hardware resources. Then, estimation expressions are created which describe the dependence among numerical amounts to evaluate the response performance of applications using the estimation expressions.

### BACKGROUND OF THE INVENTION

The present invention relates to a method for evaluating, under various utilization conditions, the response performance of one or more applications (hereinafter abbreviated AP) operating in a computer system.

As the e-business grows, corporate computer systems supporting that business are getting larger and more complicated. At the same time, various and diversified APs are supplied to the user with the result that a plurality of APs coexist in the same computer system.

In a simple computer system where one AP operates, it is possible to evaluate the maximum load that ensures practical response times by gradually increasing the number of users who work with the AP per unit time.

However, as more APs are supplied to the user, the user's system utilization cannot be represented by one dimensional axis, which indicates only the amount of load, but must be represented in a higher dimensional space. In addition, as more APs are supplied to the user, it becomes more difficult to evaluate the response time of APs which is one of the factors the user places particular emphasis. For example, two APs that share the same hardware resource, if executed at the same time, would reduce the processing speed immediately. In such a case, it is apparently meaningless to measure the response performance of one AP with the other being stopped.

As described above, a need arises for a method for evaluating the response performance of APs that is compatible with various user utilization conditions.

Three evaluation methods are known:

evaluation by real system, evaluation by simulation, and evaluation by queuing theory.

Evaluation by real system is a method for evaluating the response performance by actually running APs on computer system devices. Because the response is measured in a real system, the result is most reliable. However, the evaluation of an AP under various conditions requires the experiment to be made repeatedly each time the condition changes.

Evaluation by simulation is a method for evaluating response performance by creating a simulation program, which simulates the operation of an AP and computer system devices, to evaluate the response performance based on the execution result. A simulation program that appropriately simulates the AP and the computer system devices would ensure highly accurate evaluation. However, the evaluation of an AP under various conditions requires the simulation to be made repeatedly each time the condition changes.

Evaluation by queuing theory is a method for evaluating response performance by creating equations representing AP operation and computer system device operation with the use of queues and then solving those equations. An analytical solution, if obtained, would make it possible to evaluate the performance of the AP under various conditions extremely easily. However, the step of representing a computer system with the use of queues and the step of solving the equations both require a person in charge of evaluation to have extremely high mathematical knowledge.

Evaluation by real system and evaluation by simulation are common in that AP response evaluation under various conditions requires an experiment or simulation to be repeated. However, it is sometimes difficult to repeat evaluation because of economic limitations or time limitations. Therefore, the problem here is how the number of experiments or simulations may be reduced when they are executed or how the response times of APs may be estimated when neither experiment nor simulation is executed.

### SUMMARY OF THE INVENTION

Such a problem is solved, in general, through regression analysis. In a word, regression analysis is a methodology that lists up several mathematical model candidates, in advance, that would describe known experiment data, selects from those candidates a mathematical model that best matches data, and estimates an unknown experiment.

Application of this method to a computer system involves two problems. A first problem is that listing up model candidates is difficult. In essence, there are an unlimited number of mathematical models that may be used as candidates and so it is impossible to measure the degree of fitness of all models. This means that a person in charge of evaluation must list up in advance several models based on his or her knowledge and experience. However, when there are a large number of elements related to response performance as in a computer system, the step of listing up candidate models is extremely difficult. If this step cannot be processed properly and irrelevant candidate models are listed up, it is more likely that, even if a model best matching experiment data is selected, valuable information in the data will not be extracted. A second problem is that, when the number of experiments is reduced, the model candidates are limited to simple ones. For example, consider that M steady load tests are made for various user's utilization conditions and that M response times are obtained for each AP. In general, a mathematical model that would describe AP response times of each AP includes a plurality of parameters and these values are estimated from experiment data. Therefore, if there are M unit of data, up to M parameters are included in the model. That is, when the number of experiments is reduced, mathematical models that may be used as candidates are limited to inflexible, simple ones. Accordingly, mathematical models that may be used as candidates are limited to those with low degree of freedom. Even if the best model is selected from the candidates, the values estimated by the model are unreliable and the difference from actual data is expected to be large. If an intended performance is not attainted, the cause of the difference from actual data cannot be explained. It is an object of the present invention to solve the problems described above.

(1) Consider how a network application (NA) is processed. When a client issues a processing request, the transaction passes through multiple server processes of the NA and network-connected devices and, finally, returns to the client. In this case, the relation described below exists.

(a) The end-to-end response time of an NA depends on the response time of the server processes of the NA and the transmission time of the network-connected devices through which the NA passes.

(b) The response time of a server process depends on the processing time of the system resources, such as the CPU and disks, of the server on which the server process operates, the response time of other server processes if the server process calls those other servers, and the transfer time of network-connected devices.

(c) The utilization of system resources of a server depends on the utilization of a plurality of server processes that share the system resources.

(d) The utilization of a server process depends on the utilization of a plurality of NAs through which the server process passes.

(e) The utilization of a network-connected device depends on the utilization of a plurality of server processes that pass through the network-connected device.

(f) The processing time of the system resources of a server depends on the utilization of the system resources.

(g) The transfer time of a network-connected device depends on the utilization of the network-connected device.

With the above relation taken into consideration, a multivariate regression analysis is made individually to solve the problems. It is extremely difficult to list up mathematical model candidates that directly describe the dependence between the end-to-end response time and the utilization of NAs. However, if the relation is divided into several, the mathematical model candidates in each stage dramatically become easy. In addition, when the user makes a steady load test corresponding to various utilization conditions, not only the end-to-end response time but also internal system performance information is obtained. This internal system performance information includes the response time of server processes, the processing time of system resources, and the transfer time and the access frequency of network-connected devices. Therefore, a small number of steady load tests, if made, would make it possible to apply highly-flexible mathematical model candidates that have a degree of freedom several times as high. Combining optimal mathematical models estimated in the stages enables the end-to-end response times of NAs to be estimated accurately in any utilization condition.

(2) If, for example, there are 10 types of NAs when making steady load tests corresponding to various user's utilization conditions, setting up three load levels for each NA results in the total load pattern of as many as 3₁₀ In practice, the experiment cannot be made for all patterns in many cases. In such a case, it is necessary to select a limited number of load patterns. Randomly selecting load patterns would produce unbalanced experiment data that will decrease the accuracy of mathematical models. However, selecting sadistically balanced load patterns with the use of the method of experimental design could increase the accuracy of mathematical models.

(3) When the above described mathematical models are used to estimate the end-to-end response time of an NA under any user utilization condition and the result is longer than the criterion, the above described mathematical models may be used to identify which server process or network-connected device requires the longest time.

(4) When statistically estimating the above described mathematical models, new mathematical models need not be applied in the following two cases. The first case is that mathematical models are self- explanatory. For example, when a server process has only the function that simply uses the CPU for a predetermined time to return a response, the response time of the server process equals the CPU processing time of the server and, in this case, the mathematical model is already given. In such a self-explanatory case, mathematical models need not be estimated. The second case is that mathematical models already created in the past are available for reuse. For example, consider a case in which this method is applied again after mathematical models were created for a computer system using this method and the network-connected devices were remolded. In this case, only two models need be updated: one is the mathematical model describing the relation between the transfer time of the network-connected devices and the utilization and the other is the mathematical model describing the relation between the utilization of the network-connected devices and the utilization of a plurality of server processes that pass through the network-connected devices. The remaining mathematical models, which are not changed, may be reused.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of the present invention.

FIG. 2 is a configuration diagram of a computer system in an embodiment of the present invention.

FIG. 3 is a diagram showing the processing of applications in the computer system.

FIG. 4 is a rooted tree graph representing the performance dependence of application 1.

FIG. 5 is a rooted tree graph representing the performance dependence of application 2.

FIG. 6 is a rooted tree graph representing the performance dependence of application 3.

FIG. 7 is an L9 orthogonal array indicating an experimental design.

FIG. 8 is a list of experiment results.

FIG. 9 is a list of experiment results.

FIG. 10 is a list of estimation expressions.

FIG. 11 is a list of estimation expressions.

FIG. 12 is a list of estimation expressions.

FIG. 13 is a table comparing the experiment values with the values generated by estimation expressions.

### DETAILED DESCRIPTION OF THE EMBODIMENTS

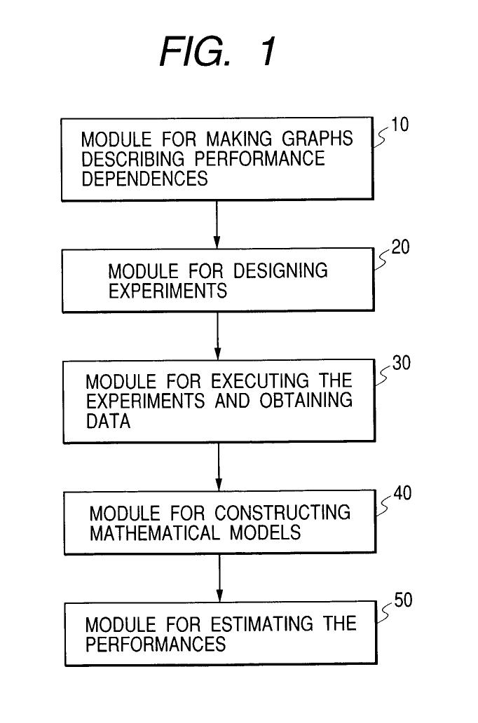

An embodiment of the present invention will be described in detail below with reference to the drawings. FIG. 1 is a configuration diagram of the present invention. A system that uses a method according to the present invention comprises a module for making graphs describing performance dependences 10, a module for designing experiments 20, a module for executing the experiments and obtaining data 30, a module for constructing mathematical models 40, and a module for estimating the performances 50.

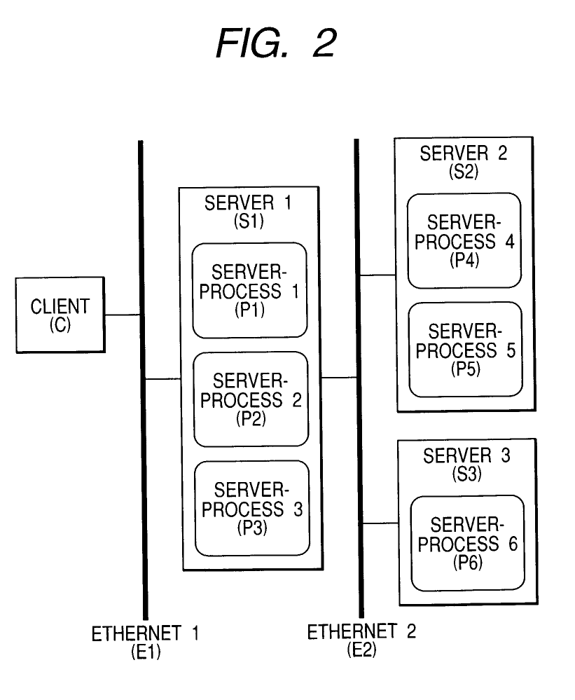

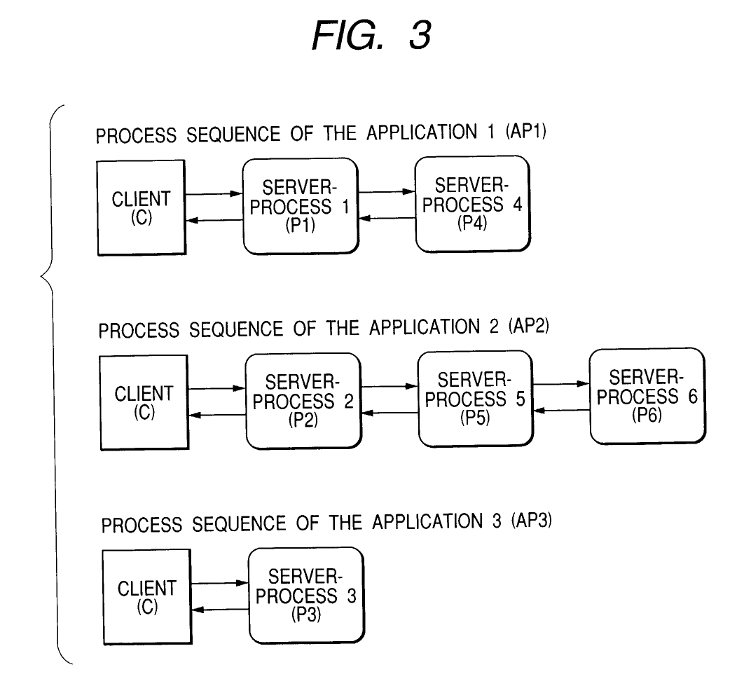

To describe each module, an embodiment will be given below. FIG. 2 is a diagram showing the configuration of a computer system of an embodiment according to the present invention. This system comprises three servers, S1, S2, and S3, a client C that gives a load corresponding to various types of utilization, and Ethernet lines E1 and E2 connecting those components. FIG. 3 is a diagram showing the processing of each AP. This computer system provides three applications AP1, AP2, and AP3. AP1 functions in coordination with server process P1 on S1 and server process P4 on S2, AP2 functions in coordination with server process P2 on S1, server process P5 on S2, and server process P6 on S3, and AP3 functions with server process P3 on S1.

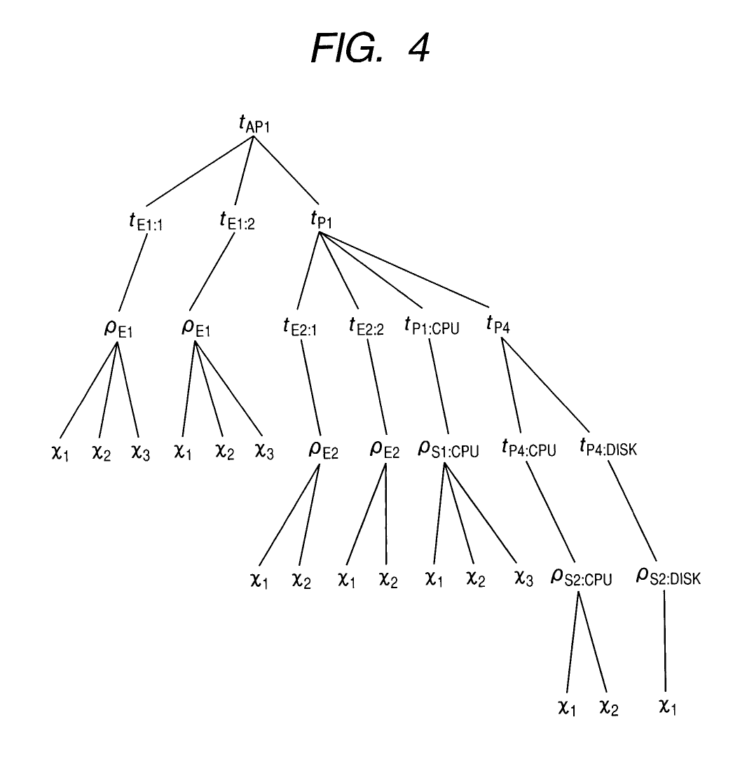

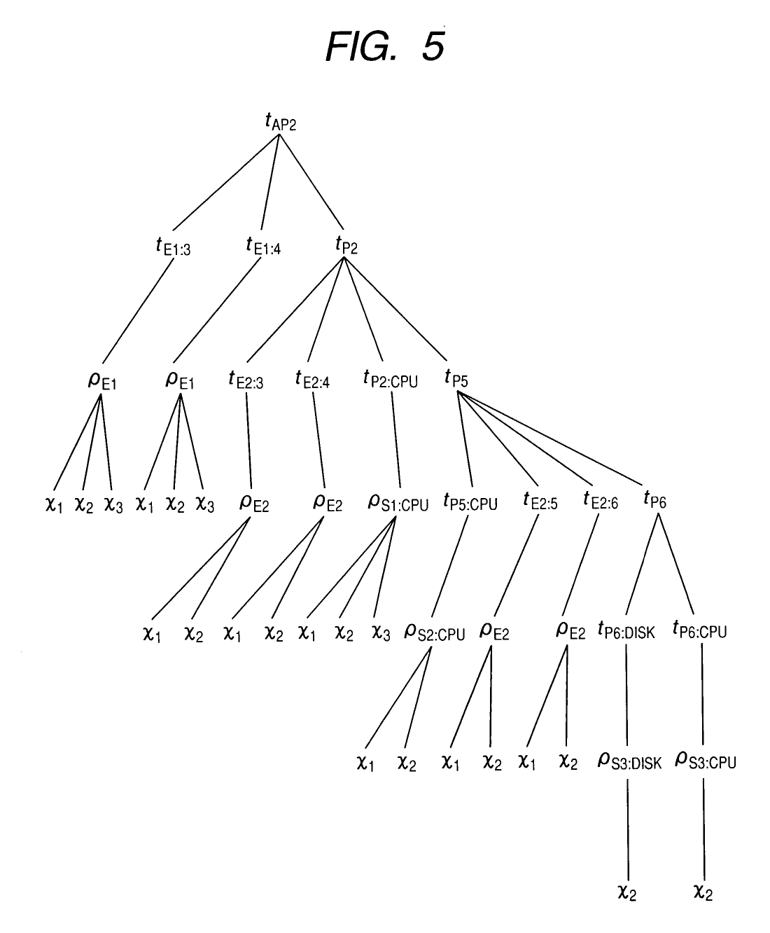

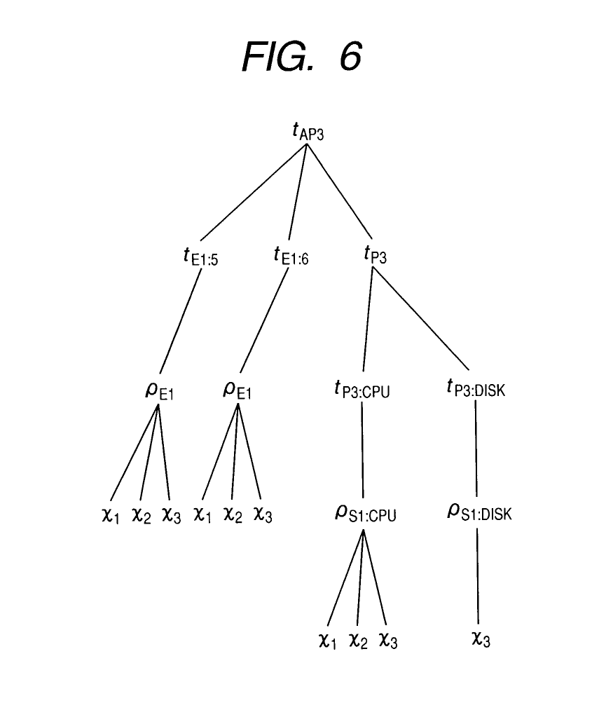

The module for making graphs describing performance dependences 10 will be described. The dependence among various response times, hardware resource utilization, and AP access frequencies of the computer system is represented by a rooted tree graph based on the above information and the specifications. FIGS. 4, 5, and 6 show the dependence of AP1, AP2, and AP3, respectively. A node, which is not a leaf, means that it depends on the adjacent node existing in the direction a leaf. This dependence will be described using AP3 in FIG. 6 as an example. The response time t_AP3 of AP3 depends on the three adjacent nodes in the leaf direction: response time t_E1:5 of E1 required for a data transmission request from C to S1, response time t_P3 of P3, and response time t_E1:6 of E1 required for a data transmission request from S1 to C. Similarly, the response time t_P3 of P3 depends on the CPU response time t_P3:CPU of S1 required for P3 and the disk response time t_P3:DISK of S1 required for P3. t_P3:CPU depends on the CPU utilization ρ_S1:CPU of S1, and t_P3:DISK depends on the disk utilization ρ_S1:CPU of S1. In addition, ρ_S1:CPU depends on x1, x2, and x3, and ρ_S1:DISK depends on x3.

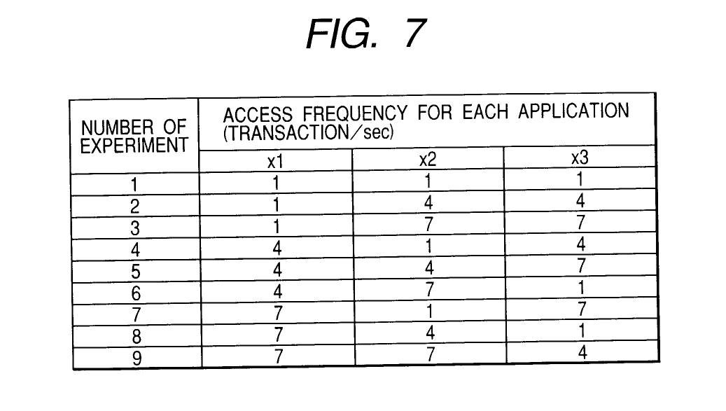

Next, the module for designing experiments 20 will be described. In the description below, it is assumed that a load test will be made within a load range in which the system runs in a steady and stable state. The access frequency per second for each application is represented as x1, x2, and x3, respectively. Also, assume that the utilization whose response time is to be evaluated corresponds to 0≦x1≦8, 0≦x2≦8, and 0≦x3≦8. If the load is set up in three levels as x1=1,4,7, x2=1,4,7, and x3=1,4,7, as many as 27 experiments must be made to check all combinations. In some cases, making such experiments might be difficult for economic reason or time reason. In such a case, partial execution based on the method of experimental design is efficient. In the description below, an L9 orthogonal array is used to reduce the number of experiments to 9. The L9 orthogonal array is shown in FIG. 7. Each column indicates an access frequency for each AP, and each row indicates the number of experiment ranging from 1 to 9. For example, the experiment indicated by the experiment number 4 indicates that the experiment will be made using x1=4, x2=1, and x3=4.

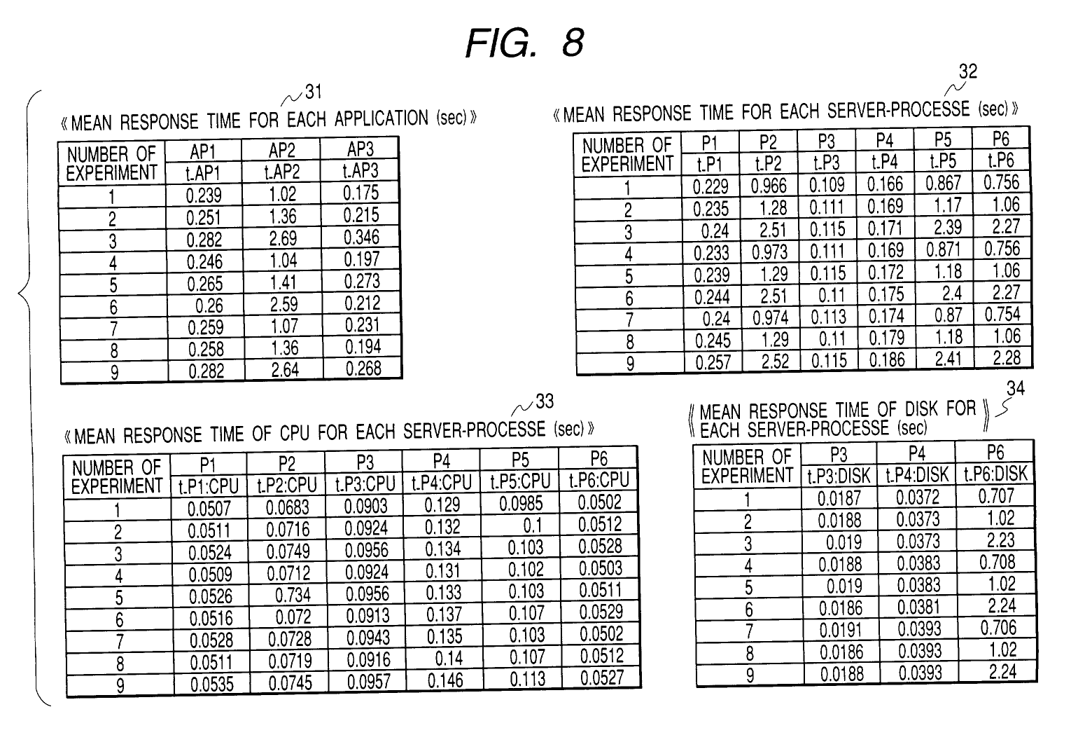

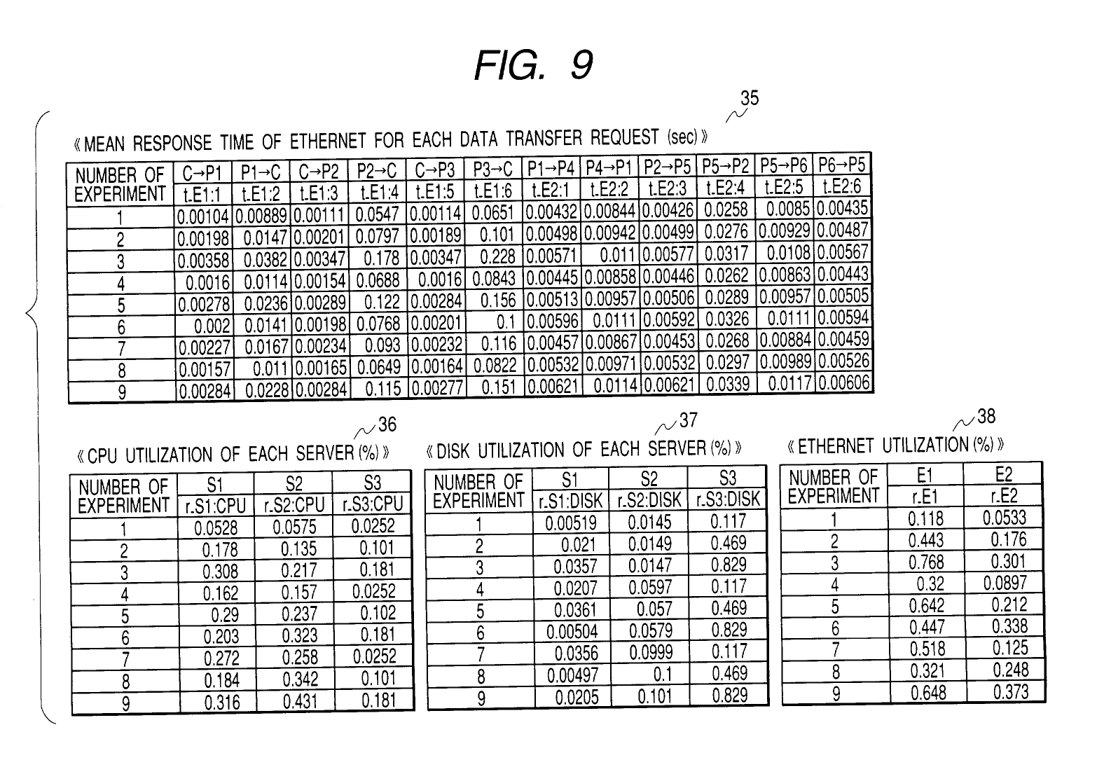

Next, the module for executing the experiments and obtaining data 30 will be described. The module for executing the experiments and obtaining data 30 makes an experiment in accordance with the experimental design set up by the module for designing experiments 20. The module measures and records a mean response time for each AP 31, a mean response time for each server-process 32, a mean response time of CPU for each server-process 33, a mean response time of disk for each sever-process 34, a mean response time of Ethernet lines for each transfer request 35, a CPU utilization of each server 36, a disk utilization of each server 37, and an Ethernet utilization 38. The measurement results according to the L9 orthogonal array are shown in FIGS. 8 and 9.

For an object to be analyzed that is evaluated by simulation, all data described above may be obtained. For an object to be evaluated by an experiment in a real system, the data may be obtained, in principle, with commercially available tools. In the description below, it is assumed that all data has been obtained. The description will be also given for a case in which only part of data may be obtained.

Next, the module for constructing mathematical models 40 will be described. In the description below, regression analysis using tree graphs is made for numeric data shown in FIGS. 8 and 9. All nodes except the leaf nodes of tree graphs in FIGS. 4, 5, and 6 are analyzed. Because it is redundant to describe the analysis process of all nodes, only two nodes are described as an example.

As the first example, the CPU utilization of S1 that are used in common by AP1, AP2, and AP3 is descriebd. The CPU utilization ρ_S1:CPU (abbreviated ρ) depends on the access frequencies x1, x2, and x3 of AP1, AP2, and AP3. Considering the interaction among AP1, AP2, and AP3, the following candidates are used as functions describing the dependence of ρ on x₁, x2, and x3.

(a) ρ=a1*x1+a2*x2+a3*x3

(b) ρ=b1*x1+b2*x2+b3*x3+b4x1*x2

(c) ρ=c1*x1+c2*x2+c3*x3+c4x1*x3

(d) ρ=d1*x1+d2*x2+d3*x3+d4x2*x3

(e) ρ=e1*x1+e2*x2+e3*x3+e4x1*x2*x3

where, a1, a2, . . . , e3, d4 are constants. For the measurement results in FIG. 7, a function with the highest degree of fitness is selected as an estimation expression. The method of least squares is used to set up the constants of each candidate as follows:

(a) a1=0.01261, a2=0.01856, a3=0.02356

$$\begin{matrix}a1 = 0.01261 , a2 = 0.01856 , a3 = 0.02356 & \text{(a)} \\ b1 = 0.01174 , b2 = 0.01768 , b3 = 0.02416 , b4 = 0.00027 & \text{(b)} \\ c1 = 0.01183 , c2 = 0.01909 , c3 = 0.02278 , c4 = 0.00024 & \text{(c)} \\ d1 = 0.01312 , d2 = 0.01783 , d3 = 0.02283 , d4 = 0.00022 & \text{(d)} \\ e1 = 0.01239 , e2 = 0.01834 , e3 = 0.02344 , e4 = 0.00004 & \text{(e)}\end{matrix}$$

Calculation of Akaike information criterion of the candidates gives (a) −20.423 (b) −22.579 (c) −21.271 (d) −20.794, and (e) −22.667. Thus, (e) is obtained as the function with the highest degree of data fitness.

As the second example, regression analysis is made for the CPU response time of S3 for P6 in AP2. The CPU response time t_P6:CPU (abbreviated t) depends on the CPU utilization ρ_S3:CPU (abbreviated ρ). According to the evaluation by queuing theory, the response time diverges by the amount of 1/(1−ρ) in the limit of ρ−>1. Thus, as a function describing the dependence of t on ρ, consider the following candidates.

(a) t=a0/(1=ρ),

(b) t=(b0+b1*ρ)/(1−ρ),

(c) t=(c0+c1ρ+c2*ρ\hat{ }2)/(1−ρ),

(d) t=(d0+d1*ρ+d2*ρ\hat{ }2+d3*ρ\hat{ }3)/(1−ρ)

where, a0, b0, . . . , d2, d3 are constants. For the measurement results in FIG. 7, a function with the highest degree of fitness is selected as an estimation expression. The method of least squares is used to set up the constants of each candidate as follows:

(a) a0=0.04606

(b) b0=0.04981, b1=−0.03659

(c) c0=0.05004, c1=−0.04315, c2=0.03109

$$d0 = 0.04210 , d1 = 0.39395 , d2 = - 5.24949 , d3 = 17.17067 \qquad ( d )$$

Calculation of Akaike information criterion of the candidates gives (a) −22.846 (b) −44.341 (c) −48.341 and (d) −48.117. Thus, (c) is obtained as the function with the highest degree of data fitness.

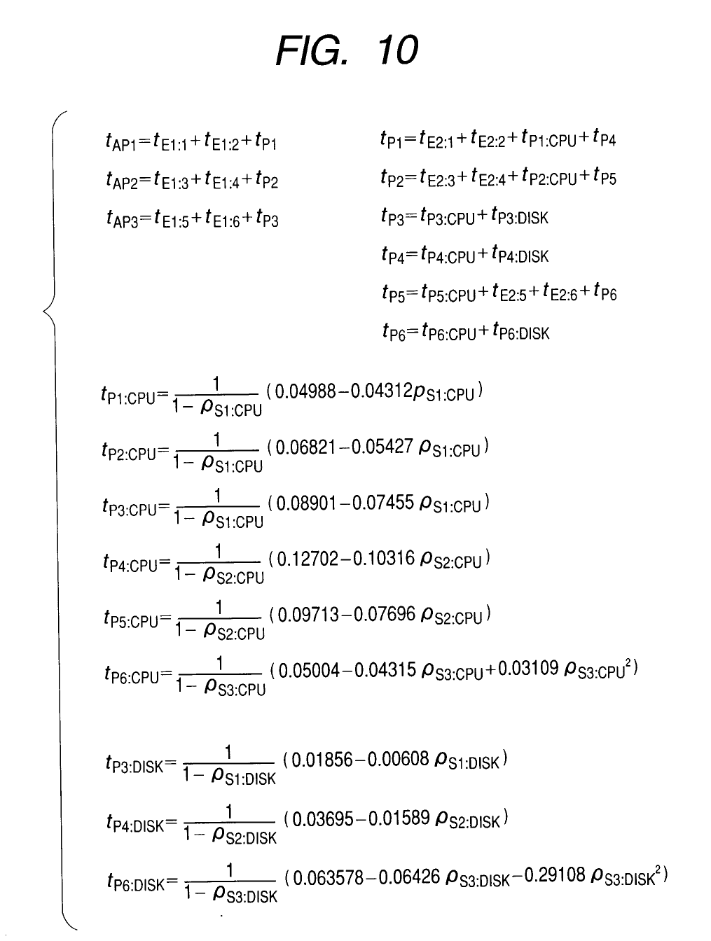

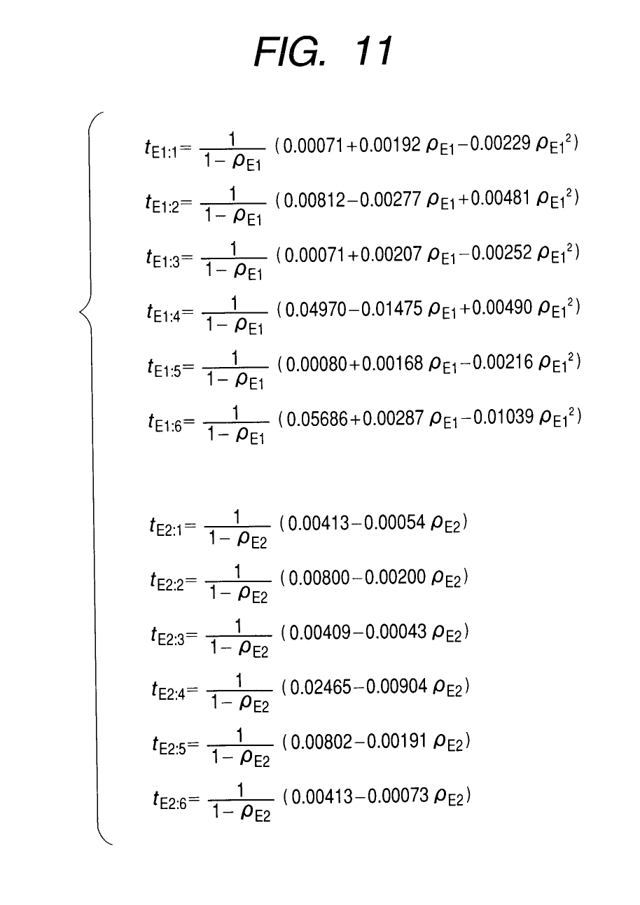

As described above, the estimation expressions corresponding to the nodes of the tree graph are obtained. The results are shown in FIGS. 10, 11, and 12. For a node, such as t_AP1, where the measurement data clearly indicates that t_AP1=t_E1:1+t_E1:2+t_P1, providing the relation is enough and there is no need for estimation expression search.

The following describes a method used when only part of data may be obtained. For example, assume that, in AP3, t_P3 may be measured but t_P3:CPU and t_P3:DISK may not. In such a case, regression analysis made with t_P3 as a function of ρ_S1:CPU (abbreviated ρ1) and ρ_S1:CPU (abbreviated ρ2).

In this case, the following candidates are considered.

(a) t=a0/{(1−ρ1)(1−ρ2)},

(b) t=(a0+a1*+ρ1+a2*+ρ2)/{(1−ρ1)(1−ρ2)},

(c) t=(a0+a1*+ρ1+a2*+ρ2+a3*ρ1*ρ2)/{(1−ρ1)(1−ρ2)}

$$t = ( a0 + a1 * ρ1 + a2 * ρ2 + a3 * ρ1 * ρ2 + a4 * ρ1 \hat{} 2 * ρ2 + a5 * ρ1 * ρ2 \hat{} 2 ) / \{ ( 1 - ρ1 ) ( 1 - ρ2 ) \} , \qquad ( d )$$

The procedure that follows is omitted because it is the same as that in the two examples given above.

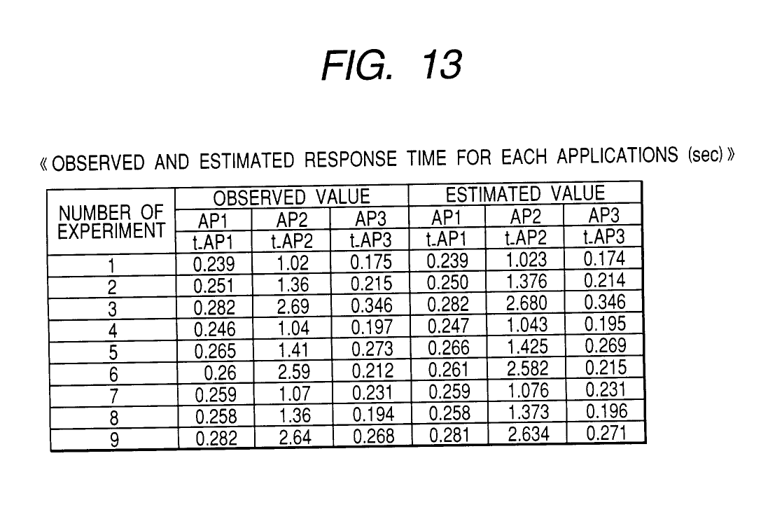

Next, the module for estimating the performances will be described. This module combines the estimation expressions in FIGS. 10, 11, and 12 and estimates the response times of AP1, AP2, and AP3 corresponding to the rooted nodes as the function of x1, x2, and x3 to check the accuracy of the estimation expressions. FIG. 13 shows the experiment values and the estimation expression values of each AP. The values in the table indicate that the mean of error between the experiment value and estimation expression value is 1% or lower.

Using these high-precision estimation expressions makes the following two types of evaluation possible.

In the first type of evaluation, the response performance of an AP, for which neither experiment nor simulation has been made, may be estimated. For example, assume that x1=7, x2=7, and x3=7. The estimation expressions give the values t_AP1=0.3108, t_AP2=2.7482, and t_AP3=0.4135. When an experiment is made to verify those values, the resulting experiment values are t_AP1=0.3160, t_AP2=2.7500, and t_AP3=0.4140. The mean of errors between the estimated values and the experiment values is 1% or lower in this case. This means that the estimation expressions show accurate system response performance.

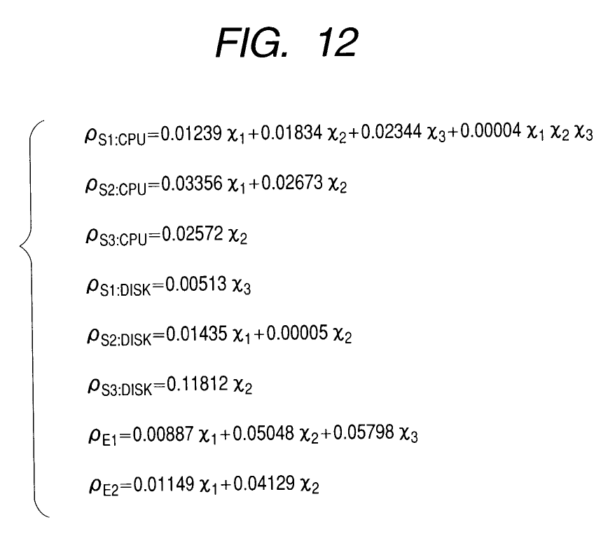

The second type of evaluation is the evaluation of elements that do not attain intended performance. The expression ρ_S3:DISK in FIG. 12 indicates that ρ_S3:DISK−>1 in the limit of x2−>1/0.11812]−8.466. Therefore, it is expected that the disk of S3 begins to fail to attain intended performance when AP2 accesses the disk about eight times per unit time and that this failure prevents the steady and stable operation of AP3. In fact, when x1=8, X2=8, and x3=8, the estimation expressions givev t_AP1=0.4305, t_AP2=6.6993, and t_AP3=0.9448 and it is expected that the response performance of t_AP2 will become a large value that exceed 6 seconds. Another experiment to verify this condition indicates that the experiment values are t_AP1=0.4310, t_AP2=6.4500, and t_AP3=0.9440. t_AP2 has exceeded 6 second as expected. Even the values close to the limit of the steady operation like this are used, the errors between the estimated values and the experiment values are 4% for t_AP2 and 1% or lower for t_AP1 and t_AP3. Those values indicate that the accuracy of the estimation expressions is extremely high.

As described above, performance information and access information on both applications and hardware resources are obtained and regression analysis is made in stages based on the dependence. This makes it possible to achieve the object of the present invention and to create estimation expressions that describe system performance accurately. As a result, it is possible to estimate the response times of applications under various conditions and to find elements that do not attain intended performance.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for estimating response performance of NAs (Network Applications) for use in a computer system infrastructure composed of a plurality of servers and network-connected devices connecting the servers,
wherein, while allowing said plurality of NAs to share system resources, a plurality of server processes operating on the same or different servers perform operation on a plurality of NAs coordinating one another over a network to provide functions, said method comprising the steps of:
(a) obtaining numerical information by making a load test that assumes various utilization, said numerical information including:
numerical information T1 on end-to-end response times of the NAs;
numerical information U1 on utilization of the NAs;
numerical information T2 on response times of the server processes;
numerical information U2 on utilization of the server processes;
numerical information T3 on transmission times of the network-connected devices;
numerical information U3 on utilization of the network-connected devices;
numerical information T4 on processing times of system resources of the servers; and
numerical information U4 on utilization of system resources of the servers;
(b) creating mathematical models based on the numerical information obtained in said step (a), the mathematical models describing:
dependence among T1, T2, T3, and T4;
dependence among U1, U2, U3, and U4;
dependence between T4 and U4; and
dependence between T3 and U3; and
(c) estimating the response performance of any of the NAs under any utilization condition by combining the mathematical models created in said step (b).

2. The method for estimating response performance of NAs according to claim 1 wherein, in said step (a), a method of experimental design is used to optimize a number of experiments.

3. The method for estimating response performance of NAS according to claim 1 wherein, when at least one mathematical model describing dependence is known in said step (b), said known mathematical model is used.

4. The method for estimating response performance of NAs according to claim 1, further comprising the step of, when the response performance of the NAs does not satisfy a criterion as a result of said step (c), identifying a server process or a network-connected device using the mathematical models, said server process or network-connected device being a major cause of not satisfying the criterion.

5. A method for estimating response performance of NAs for use in a computer system infrastructure composed of a plurality of servers and network-connected devices connecting the servers,
wherein, while allowing said plurality of NAs to share system resources, a plurality of server processes operating on the same or different servers perform operation on a plurality of NAs coordinating one another over a network to provide functions, said method comprising the steps of:
(a) obtaining numerical information by making a load test that assumes various utilization, said numerical information including:
numerical information on end-to-end response times of the NAs;
numerical information on utilization of the NAs;
numerical information on response times of the server processes;
numerical information on utilization of the server processes;
numerical information on transmission times of the network-connected devices;
numerical information on utilization of the network-connected devices;
numerical information on processing times of system resources of the servers; and
numerical information on utilization of system resources of the servers;
(b) creating mathematical models based on the numerical information obtained in said step (a), the mathematical models describing dependence among the numerical information; and
(c) estimating the response performance of any of the NAs under any utilization condition using the mathematical models obtained in said step (b).

6. The method for estimating response performance of NAs according to claim 5 wherein, in said step (a), a method of experimental design is used to optimize a number of experiments.

7. The method for estimating response performance of NAs according to claim 5 wherein, when at least one mathematical model describing dependence is known in said step (b), said known mathematical model is used.

8. The method for estimating response performance of NAs according to claim 5, further comprising the step of, when the response performance of the NAs does not satisfy a criterion as a result of said step (c), identifying a server process or a network-connected device using the mathematical models, said server process or network-connected device being a major cause of not satisfying the criterion.
